(19) United States
(12) Patent Application Publication
(10) Pub. No.: US 2005/0102390 A1
(43) Pub. Date: May 12, 2005

(54) System and method of network usage analyzer

(76) Inventors: Eric M. Peterson, Fort Collins, CO (US); N. Lee Rhodes, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/691,262

(22) Filed: Oct. 22, 2003

(51) Int. Cl. G06F 15/173; G06F 15/16

(52) U.S. Cl. 709/224; 709/203

(57) ABSTRACT

A network analyzer comprises a network query client residing in a first network, and a network query server residing in a second network protected by a firewall. The network query server is operable to collect usage data associated with the second network and respond to at least one query regarding usage of the second network from the network query client.

### BACKGROUND OF THE INVENTION

Tools now exist for gathering network usage data and presenting the data to the user with business intelligence. These tools are used to analyze and transform raw network usage data to information that a network operator can readily apply to its business model. For example, from the network resource usage pattern, the network operator may adapt the service plan(s) it offers in a given geographical region to generate more revenue.

Existing network usage analysis tools have difficulty penetrating network firewalls and other security measures used to protect computer networks. Network firewalls permit only a portion of traffic to pass between two or more connected computer networks, such as only web browsing and electronic mail traffic. Therefore, network analysis applications situated in one computer network have difficulty gaining access to another network shielded by a firewall in which network nodes of interest reside.

### SUMMARY OF THE INVENTION

In accordance with an embodiment of the present invention, a network analyzer comprises a network query client residing in a first network, and a network query server residing in a second network protected by a firewall. The network query server is operable to collect usage data associated with the second network and respond to at least one query regarding usage of the second network from the network query client.

In accordance with another embodiment of the invention, a method for accessing information of resource usage in a first network comprises establishing a communication channel between a network query client residing in a second network and a network query server residing in the first network protected by a firewall, receiving, by the network query server, at least one network usage query from the network query client, collecting, by the network query server, information requested by the at least one network usage query, and sending, by the network query server, the collected information to the network query client.

In accordance with yet another embodiment of the present invention, a method for accessing information of resource usage in a first network comprises establishing a communication channel between a network query client residing in a second network and a network query server residing in the first network protected by a firewall, sending, by the network query client, at least one network usage query to the network query server, and receiving, by the network query client, information related to the network usage query collected by the network query server.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of an embodiment of a system and method of network usage analyzer according to the present invention; and

FIG. 2 is a message flow diagram of an embodiment of a system and method of network usage analyzer according to the present invention.

### DETAILED DESCRIPTION OF THE DRAWINGS

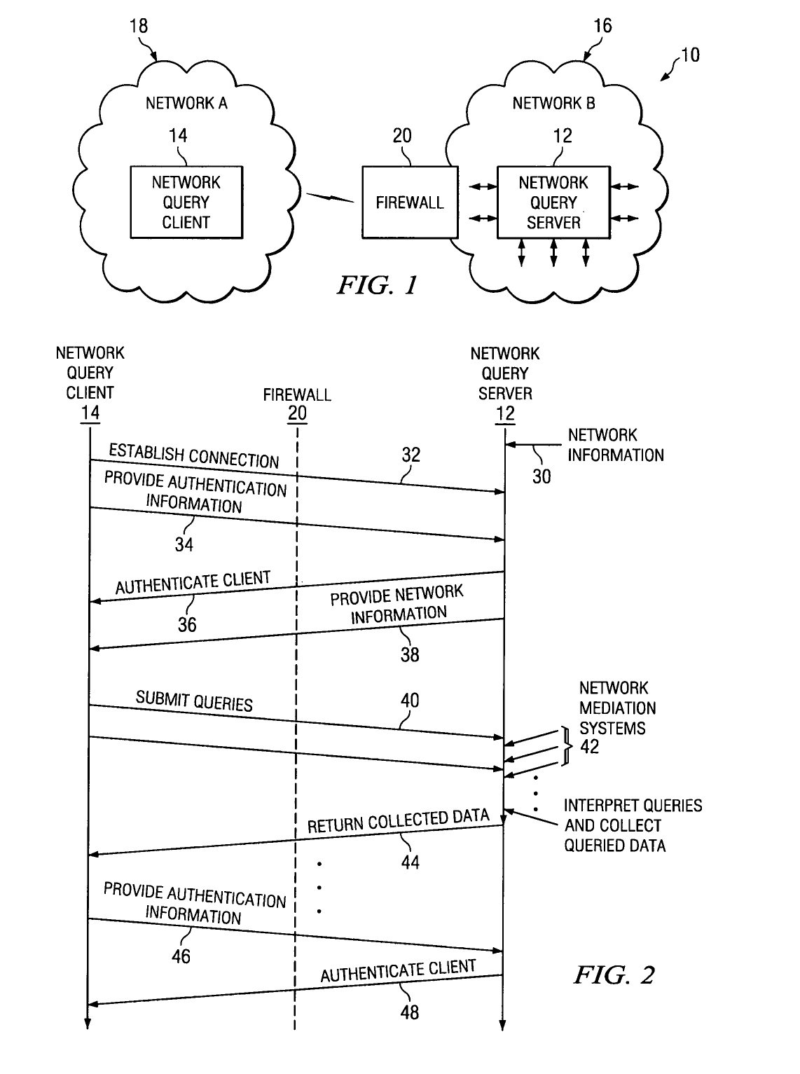

The preferred embodiment of the present invention and its advantages are best understood by referring to FIGS. 1 and 2 of the drawings, like numerals being used for like and corresponding parts of the various drawings.

FIG. 1 is a simplified block diagram of an embodiment of a system and method of network usage analyzer 10 according to the teachings of the present invention. System 10 has two main components, a network query server 12 and a network query client 14. Network query server 12 resides in network B 16, which is the computer network being monitored. Computer network B is protected by a firewall 20 that only permits authorized traffic to reach computer network B. Firewall 20 is used herein to refer to any hardware and/or software device that is operable to block network traffic in one or both directions based on some criteria. Network query server 12 may comprise hardware and/or software and is operable to access collected network usage data from one or more software applications, databases, or other sources in response to queries issued by network query client 14. The INTERNET USAGE MANAGER from HEWLETT-PACKARD COMPANY is one such system that is operable to target specific nodes in a network and collect real-time network usage data therefrom. Other suitable network mediation hardware and/or software may be used.

Network analysis client 14 resides in a second computer network A 18. Using Simple Object Access Protocol (SOAP) or another suitable protocol, network query client 14 may communicate with network query server 12 across firewall 20. Upon receiving the query from network query client 14, network query server 12 may generate replies comprising suitable network usage data and transmit the replies to network query client 14. Network query client 14 may then analyze the network usage data and transform the data into business information that network operators and other users can readily use. An example of the capability of data transformation, modeling and analysis is embodied in Hewlett-Packard's DYNAMIC NETVALUE ANALYZER.

SOAP is a protocol that relies on Hypertext Transfer Protocol (HTTP) as the underlying transport mechanism. HTTP is also currently the transport mechanism for browsing the World Wide Web. HTTP traffic is able to pass through by most firewalls or other hardware and software security devices. SOAP specifies how to encode or decode an HTTP header so that two distributed applications residing in two different computing platforms may communicate. SOAP can also specify how to encode or decode an XML (eXtensible Markup Language) file so that the two distributed application may pass information. XML is a simple and extensible text markup language that specifies character data encoding using the Universal Character Set (UCS). With this standardization, any XML data stream so encoded can be understood by any platform. This makes XML a good choice for describing method invocations or passing data in a platform and language-neutral manner. Therefore by using SOAP or similar protocols now known or to be developed, network query client 14 queries can pass through firewall 20 to reach network query server 12, and network usage data from network query server 12 can pass through firewall 20 to reach network query client 14. In this manner, network query server 12 and network query client 14 can coordinate and operate to pass relevant network usage data and other information from network query server 12 to network query client 14.

Other protocols similar to SOAP currently exist. For example, COM (Component Object Model) Internet Services (CIS) makes it possible to use DCOM (Distributed Component Object Model) with HTTP. The use of HTTP makes it possible for network query client 14 and network query server 12 communicate through firewall 20. However, because CIS is platform-specific, it is not as flexible as SOAP. Another currently known platform-specific protocol that may be substituted for SOAP is Remote Data Services (RDS). RDS makes it possible to instantiate custom business objects on remote servers over HTTP. Therefore, RDS can also be used with HTTP for communications through firewall 20. These are but two examples of mechanisms that may be used to facilitate the transmission of information between network query server 12 and network query client 14 through one or more firewalls. Suitable protocols or mechanisms later to be developed may also be substituted for SOAP. Similarly, because HTTP is currently the ubiquitous transport mechanism used by a large percentage of computing platforms, and is therefore permitted to pass through firewalls, it is the preferred transport mechanism for carrying out embodiments of the present invention. However, it should be understood that other suitable protocols now known or to be developed can be substituted therefor.

FIG. 2 is a message flow diagram of an embodiment of a system and method of network analysis query service according to the teachings of the present invention. Network query server 12, at start up or at other times, receives information related to the network 30 from data sources such as an network usage data manager, network mediation system (e.g. INTERNET USAGE MANAGER described above) or other suitable sources. Network information 30 may comprise the location of statistical engines, devices or users that consume network resources, and information related to network usage configuration. Network usage configuration may comprise the plans, services, geographical region, data metrics, etc. related to network resource usage. Network query client 14 residing in network A initiates and establishes a connection 32 with network query server 12 residing in network B. This connection is preferably a HTTP connection in which data and message exchange is done via SOAP. Other suitable protocols now known or later developed may also be used.

A series of authentication and validation procedures is followed in which network query client 14 supplies authenticating information 34 to network query server 12, and network query server 12 verifies and authenticates the provided information 36. Network query server 12 transmits information related to the network 38 to network query client 14. This network information may encompass all or a subset of the network information 30 received by network query server 12, and may additionally comprise other information related to the network and users. Network query client 14 begins to transmit one or more queries 40 to network query server 12 to obtain data related to network usage. These queries may request data related to specific plans, services, users, geographic region, and/or other metrics. The queries may ask, for example: How much total network traffic is a particular network device or user generating? How much network traffic is passed between two particular network nodes or users? What time of the day does the traffic peak in the Southwest region? Which users are heaviest consumers of network resources? What kind of network traffic (protocol) is most heavily used by the users? How much network resource usage is by users in the small business plan? The above examples are merely illustrative of the queries that may be posed by network query client 14 to network query server 12 and do not represent an exhaustive list.

Upon receiving the queries, network query server 12 interprets the queries, and requests data from one or more sources of information to obtain the queried information 42. The collected information is transmitted 44 to network query client 14. In this manner, network query server 12 received queries from network query client 14, gathers the requested information from data sources such as the INTERNET USAGE MANAGER or other network mediation systems, and relays the requested information back to network query client 14. Since HTTP is the underlying transport mechanism and HTTP traffic is permitted by most firewalls, the communications channel between network query client 14 and network query server 12 is able to seamlessly pass through any firewall erected between the network being monitored and network query client 14. No reconfiguration of the firewall is needed for network query client 14 and network query server 12 to communicate with one another. Such firewall reconfiguration is impractical and impracticable. Periodically, network query client 14 may be requested to re-authenticate by supplying authentication information 46 to network query server 12 to maintain the connection therebetween.

Because firewalls and similar gateways have become an important tool to protect computer resources and networks, distributed software applications that span multiple networks need to maintain the ability to communicate with one another despite the operation of such security devices. Embodiments of the present invention provide for splitting a network analyzer such as the DYNAMIC NETVALUE ANALYZER into two components, a network query server residing in the network being monitored and behind the firewall, and the other, a network query client, residing outside the firewall. The use of an agreed-upon protocol that is permitted by the firewall for transmitting the messages between the two components makes it possible for them communicate.

Embodiments of the present invention are also applicable to other applications that need to access data or computing resources protected by a firewall. Such embodiments place a first component of an application in the same network as the data source or computing resources to which it accesses so that it is on the same side of the firewall, and places a second component of the application outside of the firewall. The first and second components are operable to communicate with one another using an agreed-upon protocol that is permitted by the firewall. In this manner, distributed applications may communicate through firewalls without requiring special configuration changes at the firewall.

1. A network usage analyzer, comprising:
a network query client residing in a first network; and
a network query server residing in a second network protected by a firewall, the network query server operable to collect usage data associated with the second network and respond to at least one query regarding usage of the second network from the network query client.

2. The network usage analyzer, as set forth in claim 1, wherein the network query client and network query server are operable to communicate using a common protocol.

3. The network usage analyzer, as set forth in claim 1, wherein the network query client and network query server are operable to communicate using Simple Object Access Protocol.

4. The network usage analyzer, as set forth in claim 1, wherein the network query server is operable to receive a query from the network query client related to how resources in the second network are used.

5. The network usage analyzer, as set forth in claim 1, wherein the network query server is operable to collect data related to how resources in the second network are used.

6. A method for accessing information of resource usage in a first network, comprising:
establishing a communication channel between a network query client residing in a second network and a network query server residing in the first network protected by a firewall;
receiving, by the network query server, at least one network usage query from the network query client;
collecting, by the network query server, information requested by the network usage query; and
sending, by the network query server, the collected information to the network query client.

7. The method, as set forth in claim 6, wherein establishing a communication channel comprises establishing a communication channel without reconfiguring the firewall.

8. The method, as set forth in claim 6, wherein establishing a communication channel comprises establishing a communication channel using Simple Object Access Protocol.

9. The method, as set forth in claim 6, further comprising:
receiving, by the network query server, authenticating information from the network query client; and
sending, by the network query server, authentication approval to the network query client.

10. The method, as set forth in claim 6, further comprising:
periodically receiving, by the network query server, authenticating information from the network query client; and
sending, by the network query server, authentication approval to the network query client in response to the periodically received authenticating information.

11. The method, as set forth in claim 6, further comprising receiving, by the network query server, network configuration information.

12. A method for accessing information of resource usage in a first network, comprising:
establishing a communication channel between a network query client residing in a second network and a network query server residing in the first network protected by a firewall;
sending, by the network query client, at least one network usage query to the network query server; and
receiving, by the network query client, information related to the network usage query collected by the network query server.

13. The method, as set forth in claim 12, wherein establishing a communication channel comprises establishing a communication channel using Simple Object Access Protocol.

14. The method, as set forth in claim 12, further comprising:
sending, by the network query client, authenticating information to the network query server; and
receiving, by the network query client, authentication approval from the network query server.

15. The method, as set forth in claim 12, further comprising receiving, by the network query client, network configuration information from the network query server.
